(19) United States
(12) Patent Application Publication
(10) Pub. No.: US 2013/0319193 A1
(43) Pub. Date: Dec. 5, 2013

(54) Apparatuses And Methods For Removing Tangled Thread

(71) Applicants: Eileen Katherine Roche, Flower Mound, TX (US); Brint Fanizza, Brooksville, FL (US)

(72) Inventors: Eileen Katherine Roche, Flower Mound, TX (US); Brint Fanizza, Brooksville, FL (US)

(73) Assignee: GREAT NOTIONS NEWS INC., Dallas, TX (US)

(21) Appl. No.: 13/486,790

(22) Filed: Jun. 1, 2012

(51) Int. Cl. B26B 27/00; B26D 3/00

(52) U.S. Cl. 83/13; 30/127

(57) ABSTRACT

Systems and methods for removing tangled thread are provided. In one embodiment, an apparatus for removing tangled thread includes a thread grasper usable to grasp on to tangled thread. The thread grasper includes a handle portion and a grasping portion. The apparatus also includes a thread cutter usable to cut the tangled thread grasped by the thread grasper. The thread cutter includes a handle portion and a blade.

### TECHNICAL FIELD

The illustrative embodiments relate generally to sewing, embroidery, and other similar applications, and more particularly, to apparatuses and methods for removing tangled thread.

### BACKGROUND

Thread is used in sewing, embroidery, and other similar applications for a variety of purposes, including the stitching together of fabric, the creation of designs, etc. When sewing or embroidery machines sew or embroider a piece of fabric, thread may sometimes become tangled adjacent the piece of fabric, including on an underside of the fabric that faces a needle plate. This type of tangled thread is sometimes called a “bird's nest.” Tangled thread can have major consequences on a sewing or embroidery operation, including causing the sewing or embroidery machine to cease operation or tear a hole in the piece of fabric. Current devices and methods fail to conveniently, properly, and/or reliably allow for the removal of tangled thread caused by sewing or embroidering a piece of fabric.

### SUMMARY

According to an illustrative embodiment, an apparatus for removing tangled thread includes a thread grasper usable to grasp on to tangled thread. The thread grasper includes a handle portion and a grasping portion. The apparatus also includes a thread cutter usable to cut the tangled thread grasped by the thread grasper. The thread cutter includes a handle portion and a blade.

According to another illustrative embodiment, an apparatus for removing tangled thread includes a thread grasper usable to grasp on to tangled thread formed on an underside of a piece of fabric. The thread grasper includes a handle portion and a hook. The apparatus also includes a thread cutter usable to cut the tangled thread grasped by the thread grasper. The thread cutter includes a handle portion and a blade. The blade has a curved cutting edge adapted to cut the tangled thread.

According to another illustrative embodiment, a method for removing tangled thread includes grasping on to tangled thread formed adjacent a piece of fabric using a thread grasper, and cutting at least a portion of the tangled thread away from the piece of fabric using a thread cutter while grasping on to the tangled thread using the thread grasper.

### BRIEF DESCRIPTION OF THE DRAWINGS

FIG. 1 is a schematic, pictorial representation of a thread grasper and a thread cutter being used to remove tangled thread from a piece of fabric in an embroidery machine according to an illustrative embodiment;

FIG. 2 is a schematic, plan view of a thread grasper, a thread cutter, and a blade cap according to an illustrative embodiment;

FIG. 3A is a schematic, side view of a thread grasper holding on to tangled thread on an underside of a piece of fabric secured by an embroidery hoop according to an illustrative embodiment;

FIG. 3B shows a thread cutter being applied to the tangled thread of FIG. 3A;

FIG. 3C shows the tangled thread of FIG. 3B after it has been removed by the thread cutter and thread grasper; and

FIG. 4 is a flowchart of a process for removing tangled thread from a piece of fabric according to an illustrative embodiment.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

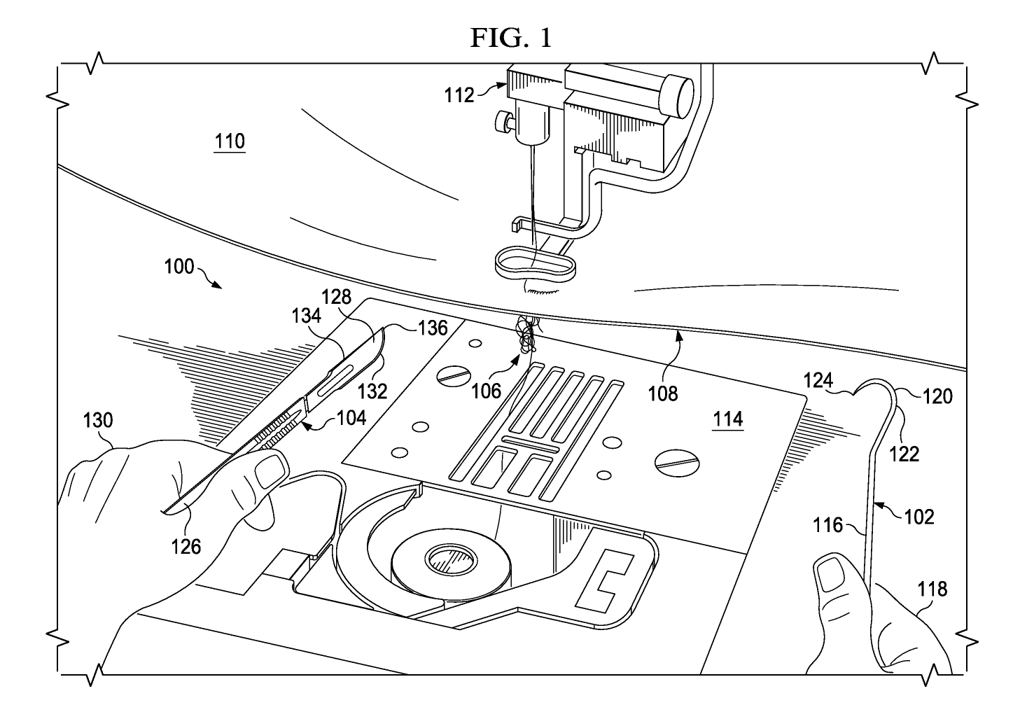

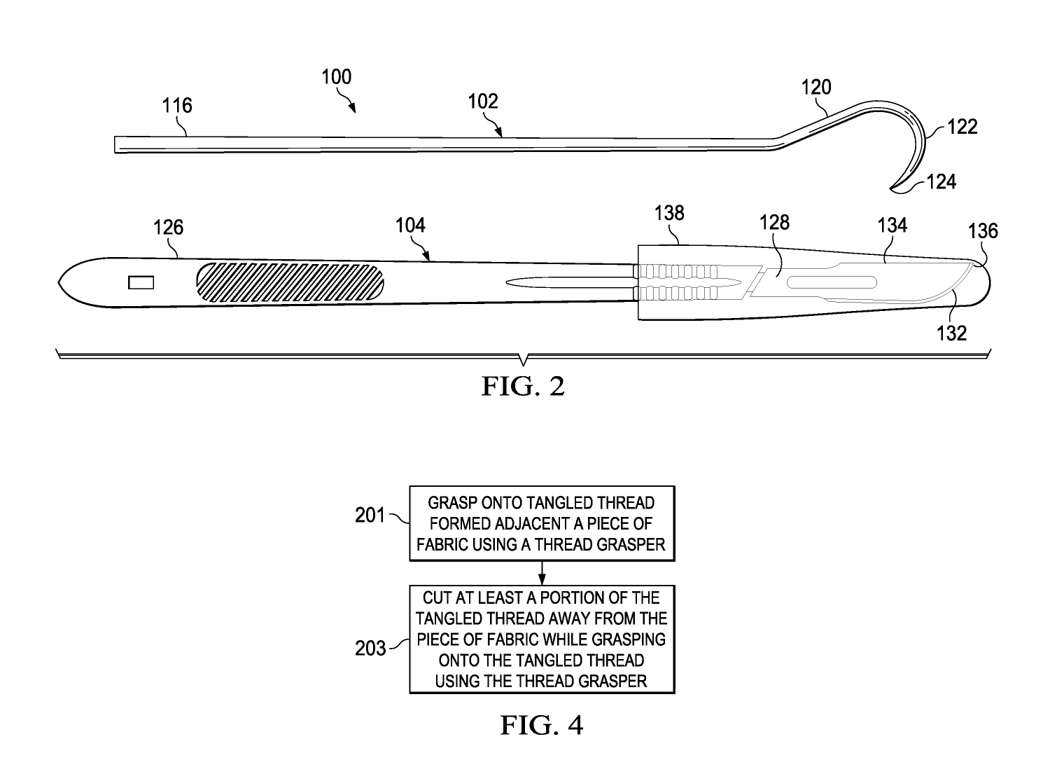

Referring to FIGS. 1 through 3C, an illustrative embodiment of a thread removing system 100 includes a thread grasper 102 and a thread cutter 104. The thread grasper 102 may be used to grasp on to tangled thread 106, sometimes known as a “bird's nest,” formed on an underside 108 of a piece of fabric 110 while the thread cutter 104 cuts away the tangled thread 106 from the piece of fabric 110. In the example of FIG. 1, the tangled thread 106 is formed while the piece of fabric 110 is being sewed or embroidered by a sewing or embroidery machine 112. Unless otherwise indicated, as used herein, “or” does not require mutual exclusivity. While the tangled thread 106 may be removed from either side of the piece of fabric 110 depending on the embodiment, in the example of FIG. 1 the underside 108 of the piece of fabric 110 on which the tangled thread 106 is formed faces a needle plate 114 of the sewing or embroidery machine 112.

The piece of fabric 110 may be composed of any type of material or substance capable of being sewn, embroidered, or otherwise threaded in any fashion, including, but not limited to, cloth, cotton, polyester, leather, synthetic material, vinyl, plastics, etc. The fabric 110 may also be a stabilizer material.

In one embodiment, the thread grasper 102 includes a handle portion 116 on to which a user's hand 118 may grasp. The other end of the thread grasper 102 may be a grasping portion 120 that is used to grasp, hold, secure, or otherwise come into contact with the tangled thread 106.

The grasping portion 120 of the thread grasper 102 may have any shape, size, or orientation that facilitates grasping of the tangled thread 106. In one example, the grasping portion 120 of the thread grasper 102 is a hook 122. The hook 122 may taper to a sharp tip 124. The sharp tip 124 may point in any direction, including away from a user, toward the user, or any direction therebetween. The hook 122 may be inserted into the tangled thread 106 so as to grasp, secure, or hold the tangled thread 106. In one non-limiting example, the hook 122 may have a substantially circular lateral cross-sectional shape, although other lateral cross-sectional shapes may be used.

In alternative embodiments, the grasping portion 120 of the thread grasper 102 may have other kinds of shapes suitable for grasping the tangled thread 106. For example, the grasping portion 120 of the thread grasper 102 may have a fork shape. The fork shape may have one, two, or any other number of tines that may be inserted into the tangled thread 106 so that the tangled thread 106 may be grasped or secured.

In one embodiment, the thread cutter 104, which may be used to cut the tangled thread 106 grasped by the thread grasper 102, may include a handle portion 126 and a blade 128. The handle portion 126 of the thread cutter 104 may be grasped by a user's hand 130 so that the thread cutter 104 may be wielded to cut the tangled thread 106. The opposite end of the thread cutter 104 may include the blade 128.

In one embodiment, the blade 128 may include a first, cutting edge 132 that is adapted to cut the tangled thread 106. The first, cutting edge 132 may have any sharpness that is suitable for cutting the tangled thread 106. The blade 128 may also include a second, non-cutting edge 134 that is opposite the first, cutting edge 132 of the blade 128. The first, cutting edge 132 of the blade 128 may taper toward the second, non-cutting edge 134 to form a pointed tip 136. In a non-limiting example, the first, cutting edge 132 may be curved.

In alternative embodiments, the blade 128 may have any size, shape, or number of cutting edges. For example, in one embodiment the blade 128 is double edged, in which case the second, non-cutting edge 134 may also have a cutting edge adapted to cut the tangled thread 106. Also, the shape of the cutting edges may be curved, straight, or any other shape. Furthermore, the first, cutting edge 132, or any other cutting edge of the blade 128, may be a smooth edge, a jagged edge, or any other type of edge adapted to cut the tangled thread 106. The thread removing system 100 may also include a blade cap 138 that is adapted to at least partially cover the blade 128. The blade 128 may be insertable and removable from the blade cap 138. In one example, the blade cap 138 may be used to cover the blade 128 when the thread cutter 104 is not being used. Use of the blade cap 138 may protect the blade 128 from damage, or protect others from being harmed by the blade 128.

The thread grasper 102 and the thread cutter 104 may be formed from any material that facilitates the functionality described herein. For example, the thread grasper 102 and the thread cutter 104 may be formed from metal, plastic, glass, or any other material. Also, different portions of each of the thread grasper 102 and the thread cutter 104 may be formed from different materials. For example, the handle portion 126 of the thread cutter 104 may be formed from a different material than the blade 128. Likewise, the handle portion 116 of the thread grasper 102 may be formed from a different material than the grasping portion 120. Furthermore, the thread grasper 102 may be formed from a different or same material than the thread cutter 104.

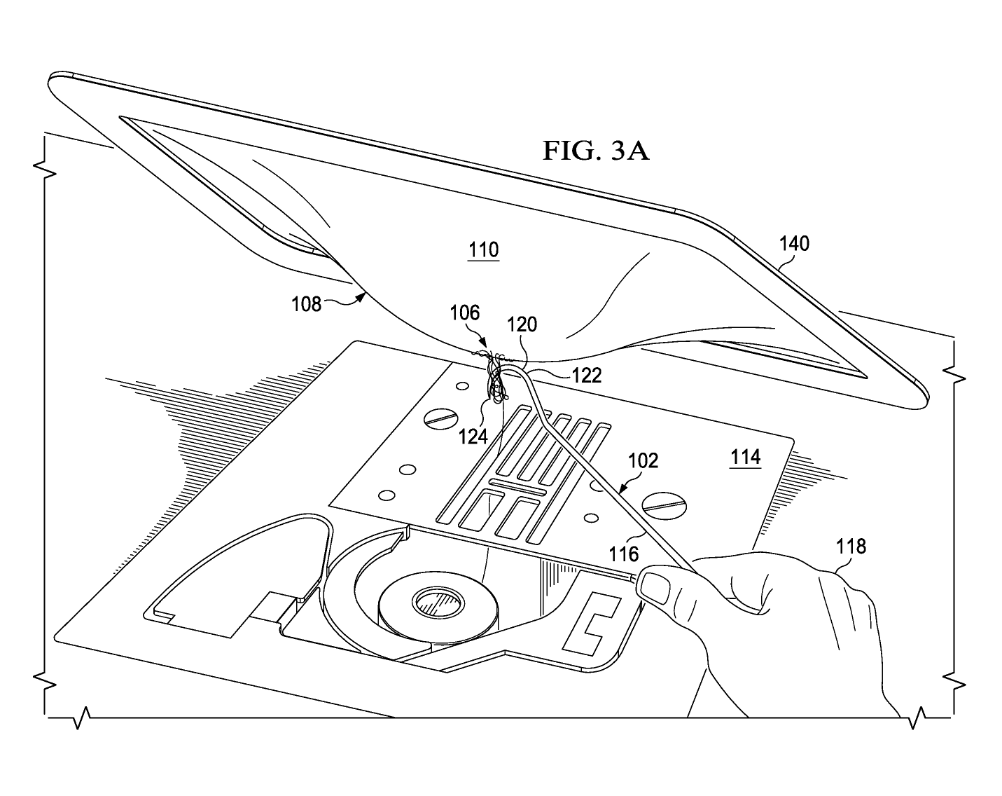

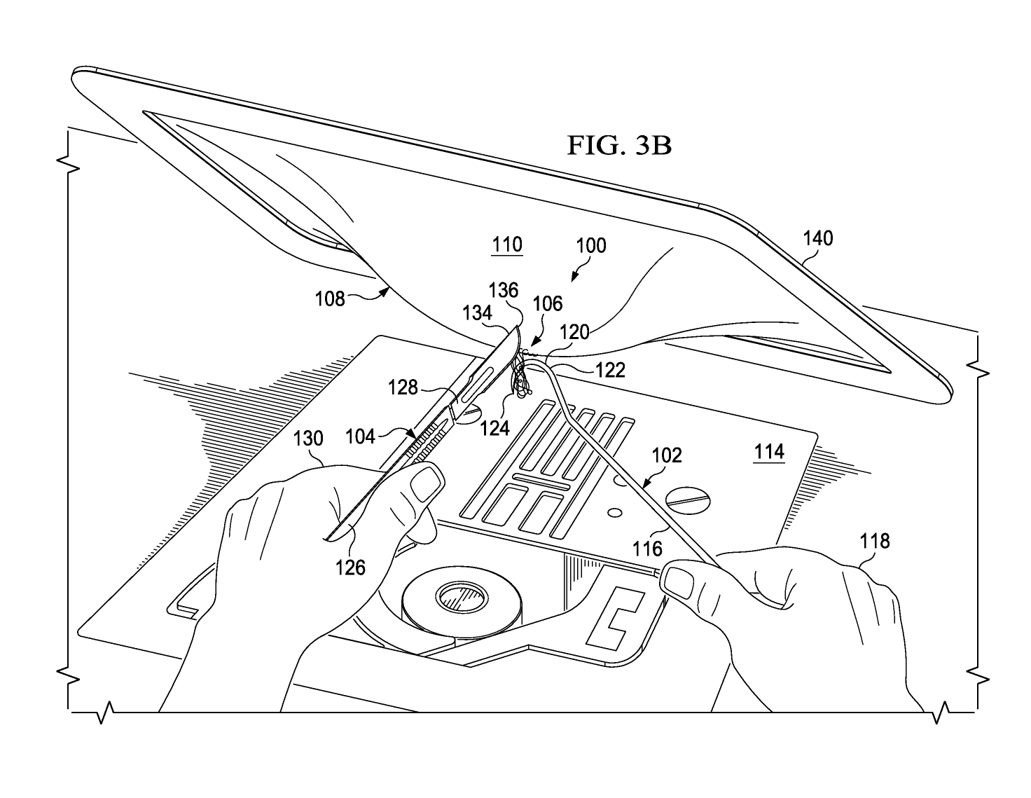

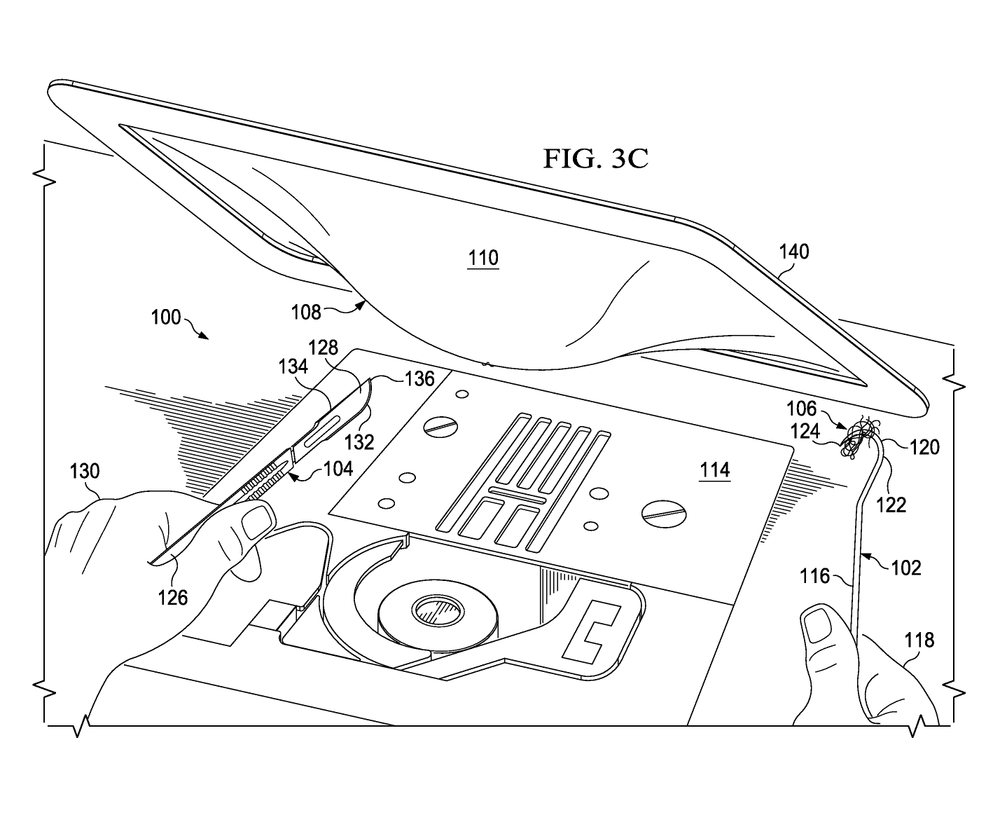

With specific reference to FIGS. 3A through 3C, operation of the thread removing system 100 may be performed on the piece of fabric 110 when it is secured by an embroidery hoop 140. In this example, the piece of fabric 110 may be embroidered by an embroidery machine 112 while the piece of fabric 110 is secured by the embroidery hoop 140. It will be appreciated that the thread removing system 100 may be utilized regardless of whether the embroidery hoop 140 is used to secure the piece of fabric 110.

As the piece of fabric 110 is being embroidered, the tangled thread 106, or bird's nest, forms on the underside 108 of the piece of fabric 110. As shown in FIG. 3A, the thread grasper 102 is held by the user's hand 118 to grasp on to the tangled thread 106 that is formed adjacent the piece of fabric 110. FIG. 3A also shows that the embroidery hoop 140, along with the piece of fabric 110 secured therein, has been lifted to expose the tangled thread 106 so as to facilitate grasping and cutting of the tangled thread 106 by the thread removing system 100.

Prior to cutting the tangled thread 106, the thread grasper 102 may also be used to pull the tangled thread 106 in such a manner to provide stability to cut the tangled thread 106 using the thread cutter 104. Referring specifically to FIG. 3B, the thread cutter 104 is being applied by the user's hand 130 to cut off the tangled thread 106 from the piece of fabric 110. The tangled thread 106 is cut from the piece of fabric 110 while the thread grasper 102 holds on to or secures the tangled thread 106. Any motion may be used to cut the tangled thread 106 from the piece of fabric 110, including by sawing the tangled thread 106 from the piece of fabric 110 using a back-and-forth motion.

Referring specifically to FIG. 3C, the tangled thread 106 has been cut off from the piece of fabric 110 and has been removed away from the piece of fabric 110 using the thread grasper 102. Now that the tangled thread 106 has been removed from the piece of fabric 110, further sewing or embroidery operations may be performed on the piece of fabric 110, if appropriate, using the sewing or embroidery machine 112. It will be appreciated that the thread removing system 100 may be performed by a user's hands in that each of the thread grasper 102 and the thread cutter 104 may be grasped by one of the user's hands, as shown in the figures.

Referring to FIG. 4, a process for removing tangled thread from a piece of fabric includes grasping on to tangled thread formed adjacent a piece of fabric using a thread grasper (step 201). The process may also include cutting at least a portion of the tangled thread away from the piece of fabric while grasping on to the tangled thread using the thread grasper (step 203).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

As used herein, including in the claims, the terms first, second, third, etc. . . . used in relation to an element (e.g., first edge, second edge, etc.) are for reference or identification purposes only, and these terms, unless otherwise indicated, are not intended to describe or suggest a number, order, source, purpose, or substantive quality for any element for which such a term is used.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. An apparatus for removing tangled thread, the apparatus comprising:
a thread grasper usable to grasp on to tangled thread, the thread grasper comprising a handle portion and a grasping portion; and
a thread cutter usable to cut the tangled thread grasped by the thread grasper, the thread cutter comprising a handle portion and a blade.

2. The apparatus of claim 1, wherein the grasping portion of the thread grasper is a hook.

3. The apparatus of claim 2, wherein the hook has a substantially circular lateral cross-sectional shape.

4. The apparatus of claim 2, wherein the hoop tapers to a sharp tip.

5. The apparatus of claim 1, wherein the tangled thread is formed on an underside of a piece of fabric while the piece of fabric is being at least one of sewed or embroidered.

6. The apparatus of claim 1, wherein the blade comprises:
a first, cutting edge adapted to cut the tangled thread; and
a second, non-cutting edge opposite the first, cutting edge of the blade.

7. The apparatus of claim 6, wherein the first, cutting edge of the blade tapers toward the second, non-cutting edge to form a pointed tip.

8. The apparatus of claim 6, wherein the first, cutting edge of the blade is curved.

9. The apparatus of claim 1, wherein the blade comprises:
a first, cutting edge adapted to cut the tangled thread; and
a second, cutting edge opposite the first, cutting edge and adapted to cut the tangled thread.

10. The apparatus of claim 1, further comprising:
a blade cap adapted to at least partially cover the blade, the blade insertable and removable from the blade cap.

11. The apparatus of claim 1, wherein the thread grasper and the thread cutter are formed from metal.

12. An apparatus for removing tangled thread, the apparatus comprising:
a thread grasper usable to grasp on to tangled thread formed on an underside of a piece of fabric, the thread grasper comprising a handle portion and a hook; and
a thread cutter usable to cut the tangled thread grasped by the thread grasper, the thread cutter comprising a handle portion and a blade, the blade having a curved cutting edge adapted to cut the tangled thread.

13. A method for removing tangled thread, the method comprising:
grasping on to tangled thread formed adjacent a piece of fabric using a thread grasper; and
cutting at least a portion of the tangled thread away from the piece of fabric using a thread cutter while grasping on to the tangled thread using the thread grasper.

14. The method of claim 13, further comprising:
pulling the tangled thread away from the piece of fabric to facilitate cutting the at least a portion of the tangled thread away from the piece of fabric.

15. The method of claim 13, further comprising:
prior to the grasping and the cutting of the tangled thread, at least one of sewing or embroidering the piece of fabric so as to form the tangled thread on an underside of the piece of fabric.

16. The method of claim 15, wherein the piece of fabric is secured by a hoop while the piece of fabric is being at least one of sewed or embroidered.

17. The method of claim 13, further comprising:
lifting the piece of fabric to expose the tangled thread so as to facilitate the grasping and the cutting of the tangled thread.

18. The method of claim 13, wherein the grasping and the cutting of the tangled thread is performable by a user having a first hand and a second hand, the user using the first hand to hold the thread grasper and the user using the second hand to hold the thread cutter.

19. The method of claim 13, wherein cutting the at least a portion of the tangled thread comprises sawing the at least a portion of the tangled thread using a back-and-forth motion.

20. The method of claim 13, wherein cutting the at least a portion of the tangled thread comprises snipping the at least a portion of the tangled thread from the piece of fabric.
